(19) United States
(12) Patent Application Publication
(10) Pub. No.: US 2006/0103633 A1
(43) Pub. Date: May 18, 2006

(54) Customizable touch input module for an electronic device

(75) Inventor: Anthony Gioeli, Los Gatos, CA (US)

Correspondence Address: HAVERSTOCK & OWENS LLP, 162 NORTH WOLFE ROAD, SUNNYVALE, CA, 94086, US

(73) Assignee: Atrua Technologies, Inc.

(21) Appl. No.: 11/058,514

(22) Filed: Feb. 14, 2005

Related U.S. Application Data
(60) Provisional application No. 60/629,169, filed on Nov. 17, 2004.

(51) Int. Cl. G09G 5/00

(52) U.S. Cl. 345/173

(57) ABSTRACT

A system having a customized interface for providing user inputs to an electronic device and a method for configuring the system is disclosed. The system comprises a user interface that includes a finger sensor and a mechanical component, both for receiving user inputs. A customizable device interface couples the user interface to an electronic device, such as a mobile telephone or a digital camera. The device interface is configured to selectively map the output of the user interface to any number of programmed inputs used by the electronic device. Any combination of components that form the user interface can thus be selected and the device interface configured so that the outputs of the components are mapped to functions recognizable by application programs executing on the electronic device. In one embodiment, for example, the output of a finger sensor is used to control a mobile phone; in another embodiment the output of the finger sensor is used to control a digital camera.

### RELATED APPLICATIONS

This application claims priority under 35 U.S.C. § 119(e) of the co-pending U.S. provisional application Ser. No. 60/629,169, filed on Nov. 17, 2004, and titled “INTELLIGENT TOUCH INPUT MODULE.” The provisional application Ser. No. 60/629,169, filed on Nov. 17, 2004, and titled “INTELLGENT TOUCH INPUT MODULE,” is hereby incorporated by reference.

### FIELD OF THE INVENTION

The present invention relates to electronic input devices. More particularly, the present invention relates to systems for and methods of customizing fingerprint sensors and mechanical controls to provide inputs to electronic devices.

### BACKGROUND OF THE INVENTION

Finger sensors are now used on an ever increasing number of electronic devices. On some electronic devices, for example, finger sensors have replaced mechanical controls, such as buttons and knobs. The use of finger sensors to replace mechanical controls, however, has several drawbacks. For example, finger sensors do not have the tactile feel that users of electronic devices, such as electronic games, enjoy. These users enjoy the feel of pushing a button, turning a steering wheel, or twisting a dial. Furthermore, many applications require some actions that are better enabled with a finger sensor while others are better served by mechanical controls such as dials, slide switches, and the like.

One alternative to using exclusively finger sensors or exclusively mechanical controls is to combine the two. Systems that combine finger sensors and mechanical controls use the two independently. The finger sensor is used to perform one function and the mechanical control is used to perform a second, independent function. The number of functions, along with the lack of interaction, provided by such independent controls is inadequate for many applications.

Systems that combine a finger sensor and a mechanical control also suffer because the outputs from the sensor and the mechanical control must be specifically tailored to the electronic device that incorporates them. For example, a first input module that combines a finger sensor and a push button to operate a mobile telephone must have two interfaces that independently translate the outputs from the finger sensor and the push button into data usable by applications executing on the mobile telephone. A second input module that combines a finger sensor and a switch to operate a digital camera must have separate interfaces that independently translate the outputs from the finger sensor and the switch into data usable by applications executing on the digital camera. These translations (and thus interfaces) are unique since the architecture of these products are different and applications executing on a mobile phone are generally different from those executing on a digital camera.

This need for unique, independent interfaces has many limitations in product design and application development resulting in a shortfall of overall appeal of multi-functional products to consumers.

### SUMMARY OF THE INVENTION

The present invention is directed to systems for and methods of customizing device interfaces. The device interfaces couple interface modules, which comprise a user interface having a finger sensor and mechanical components, to an underlying electronic device. In accordance with the present invention, any number of user interfaces are able to be selected, based on their look and function, and are coupled to an electronic device. A user thus has more options in selecting how to use an electronic device. Moreover, this customization allows a manufacturer to increase the number of functions that the electronic device, controlled using the user interface, can perform. For example, the user interface is able to be customized so that applications executing on the electronic device are able to recognize and differentiate between more combinations of inputs from the user interface.

In a first aspect of the present invention, a system for providing an input to an electronic device comprises a user interface for receiving user input, coupled to a device interface. The user interface comprises a finger sensor and a mechanical input component. The device interface is configured to selectively map an output of the user interface to an input for the electronic device. The mechanical input component includes any one or more of a push button, a scroll wheel, a joy stick, a touch pad, a switch, a dial, and a pressure sensor. The input for the electronic device corresponds to a cooperative mapping of the output of the finger sensor and the output of the mechanical input component.

In a preferred embodiment, the input for the electronic device corresponds to a function supported by an application program executing on the electronic device. The function includes any one of scrolling through a list of telephone numbers, selecting a telephone number, and automatically dialing a selected telephone number. In one embodiment, the electronic device is a game device, and the function includes any one of generating a computer game display and controlling the game display. In another embodiment, the electronic device is a digital camera, and the function includes any one of focusing the digital camera and capturing a picture on the digital camera. Preferably, the user interface and the device interface are configured to form an integrated module with the electronic device.

In one embodiment, the device interface comprises a memory containing a sequence of executable program instructions for mapping the output of the user interface to the input for the electronic device. Alteratively, the device interface comprises an application specific integrated circuit configured to map the output of the user interface to the input for the electronic device.

In another embodiment, the system further comprises an authentication unit coupled to the finger sensor. The authentication unit authenticates a user using finger image data read by the finger sensor. In another embodiment, the input for the electronic device depends on a context of the application program.

Preferably, the finger sensor is a swipe sensor, such as an optical sensor, a thermal sensor, or a capacitive sensor. Alternatively, the finger sensor is a placement sensor.

In another embodiment, the user interface further comprises any one or more of an LED, an LCD panel, a back light, and a speaker.

In a preferred embodiment, the system further comprises an electronic device coupled to the device interface. The electronic device is any device controllable by the user interface, such as a mobile telephone, a portable computer, a digital camera, a portable game system, a game controller, a personal digital assistant, a digital audio player, and a digital video player.

In a second aspect of the present invention, a system comprises an electronic device, a finger sensor for receiving a first input to control the electronic device, and a mechanical input portion for receiving a second input to control the electronic device. The finger sensor and the mechanical input portion are configured to operate cooperatively with each other to control the electronic device.

In a third aspect of the present invention, a method of configuring an electronic system comprises selecting a user interface comprising a finger sensor and a mechanical component; selecting an electronic device; and configuring a device interface between the user interface and the electronic device. The device interface is configured to cooperatively map an output from the finger sensor and an output from the mechanical component to an output for controlling an application executing on the electronic device.

### BRIEF DESCRIPTION OF THE DRAWINGS

FIG. 1 is a schematic perspective view of a mobile telephone having a customizable interface module for scrolling through a list of telephone numbers and automatically dialing a selected telephone number in accordance with the present invention.

FIG. 2 shows the relationship between a user interface, a customizable device interface, and an application program executing on the mobile telephone of FIG. 1 in accordance with the present invention.

FIG. 3 shows a table illustrating the mapping between the components of the interface module of FIG. 1 and the corresponding function within the application program that each performs.

FIG. 4 shows a display screen and a customizable interface module of a mobile telephone that executes a computer game emulating a racing car in accordance with the present invention.

FIG. 5 shows a table illustrating the mapping between the components of the interface module of FIG. 4 and the corresponding function within the computer game that each performs.

FIG. 6 shows a display screen and a customizable interface module of a digital camera in accordance with the present invention.

FIG. 7 shows a table illustrating the mapping between the components of the interface module of FIG. 6 and the corresponding function that each performs on the digital camera.

FIG. 8 shows an architecture comprising a customizable device interface in accordance with one embodiment of the present invention.

FIG. 9 is a flow chart depicting the steps to configure a customizable device interface in accordance with the present invention.

FIGS. 10-14 show face plates having various interface modules, configurations, and shapes and used with customizable device interfaces in accordance with the present invention.

### DETAILED DESCRIPTION OF THE PREFERRED EMBODIMENT

In accordance with the present invention, an electronic housing containing a user interface is able to be integrated with any number of electronic devices, such as a mobile telephone, a digital camera, a game device, and a game controller. Preferably, the user interface contains input components, including a finger sensor and one or more mechanical input components, such as a push button, a scroll wheel, a joy stick, a touch pad, a dial, and a pressure sensor. The user interface is configured to provide to a host system electronic signals, data, and control information corresponding to electronic signals, data, and control information generated by a user input device. Alternatively, the user interface also contains output components such as speakers, light emitting diode (LED) displays, and liquid crystal displays (LCDs). Using a method of the present invention, a user is able to select a housing to suit his particular needs, select an electronic device, and then have an interface between the housing and the electronic device customized so that the user interface provides the functions needed or supported by the electronic device and the applications running on it. A user is thus able to select housings based on their look and feel, the types and number of input components they have, or any other criteria.

Embodiments of the present invention are able to be used with many application programs including, but not limited to, a telephone application program, a game application program, and a digital camera application program, all of which support various functions. For example, the telephone application program supports the functions of displaying a list of telephone numbers, scrolling through the list, selecting a telephone number in the list, and automatically dialing the selected telephone number.

In accordance with the present invention, a user is able to choose a product with a desirable housing having a finger sensor and a push button as part of the user interface. The user then selects a mobile telephone as the electronic device because he wishes to use the electronic device to store phone lists and then dial phone numbers selected from the phone list. A first device interface between the user interface and the mobile phone is then customized so that the finger sensor is used to scroll through the phone list and the push button is used to automatically dial a selected telephone number. Still in accordance with the present invention, the user selects a second product with a housing having the same user interface, but selects a digital camera as the electronic device, having different requirements of the user interface. In one embodiment, the finger sensor is now used to focus the lens of the digital camera. In this embodiment, the device interface is now customized so that the finger sensor controls the focus of the lens as needed. As described in more detail below, customizing the device interface in accordance with the present invention comprises mapping each component of a user interface (e.g., an output of a finger sensor, of a push button, of a scroll wheel, etc.) to a particular function used by the electronic device or an application executing on the electronic device. Preferably this mapping is performed by software but alternatively is performed by hardware components such as an application specific integrated circuit (ASIC).

The present invention allows device interfaces to be customized when the electronic device is assembled, allowing the electronic devices to be paired with any number of suitable housings having any number of device interfaces. This flexibility reduces production time and costs and eliminates the need for a universal device interface that may not be optimal to fit a particular application. This mapping also allows greater flexibility in what functions the user interface can support. For example, a finger sensor and a mechanical input component are able to be mapped to more functions. As one example, swiping a finger sensor on the user interface maps to one function (e.g., authenticate the identity of a user, verifying that he has the right to use a mobile telephone), swiping the finger sensor while pressing a push button maps to another function (e.g., scroll through a phone list displayed on the mobile telephone), and pressing the push button alone maps to another function (e.g., dial a selected telephone number). Thus, embodiments of the present invention allow a finger sensor and a mechanical input component to be used cooperatively, in conjunction with one another, to increase the number of available functions supported by a user interface.

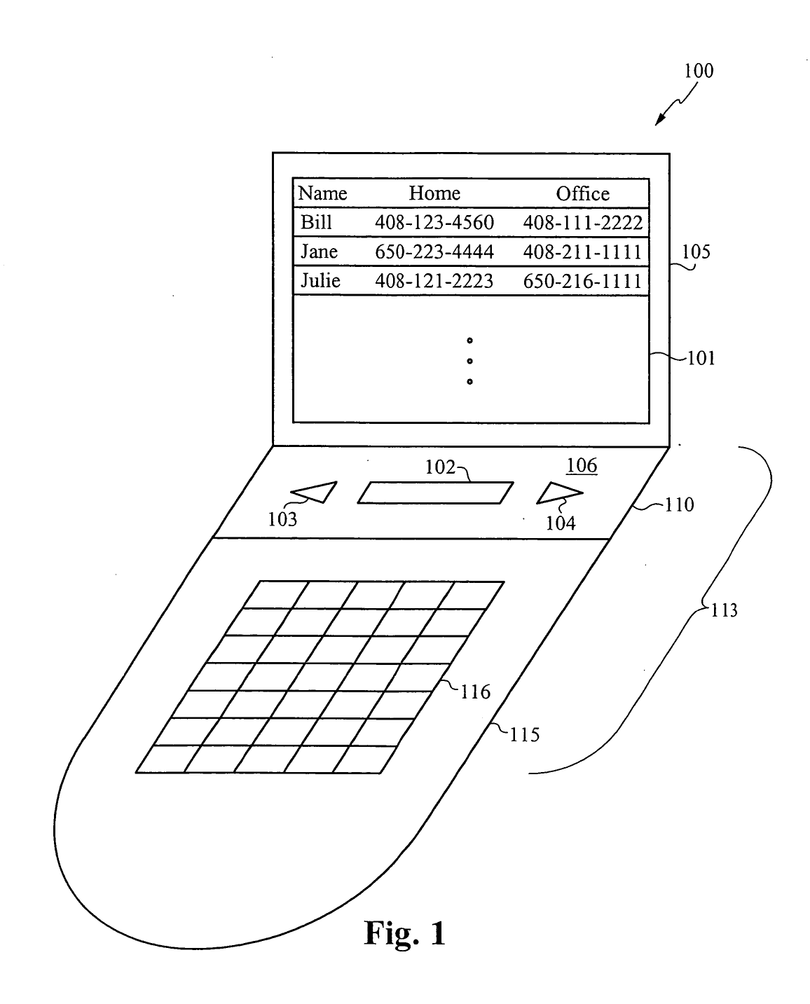

FIG. 1 shows a mobile telephone 100 having a customizable device interface in accordance with the present invention. The customizable device interface has been customized to allow the mobile telephone 100 to control a telephone application program executing on the mobile telephone 100. The exemplary interface allows a user to scroll through a phone list, select a telephone number, and automatically dial the selected telephone number. In other embodiments, the customizable device interface is customized to perform other tasks, such as to control a computer game executing on the mobile telephone 100.

The mobile telephone 100 has a lid 105 coupled to a hand set 113. The lid 105 contains a display screen 101 displaying a list of names and corresponding home and telephone numbers generated by the telephone application program. The hand set 113 comprises a user interface module 110 and a bottom section 115, which contains a number pad 116. The user interface module 110 comprises a user interface 106 and a customized device interface (not shown). The device interface couples the user interface 106 to the telephone application program. As described in more detail below, the device interface is customized in accordance with the present invention.

The user interface 106 comprises user interface components including a finger sensor 102, a left arrow button 103, and a right arrow button 104. Each user interface component is mapped to a function executed by the telephone application program.

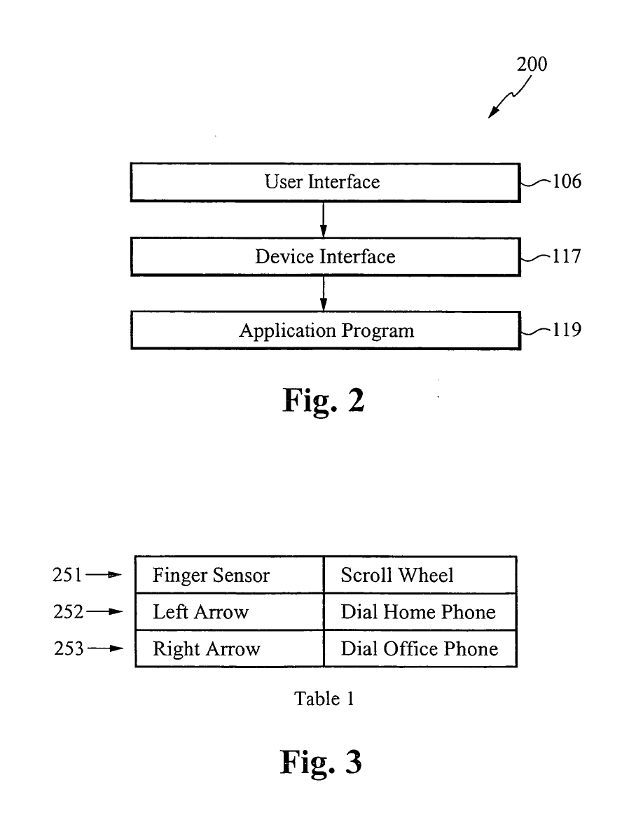

FIG. 2 shows the relationship between the user interface 106, the telephone application program 119, and a customizable device interface 117 operationally coupling the user interface 106 to the telephone application program. In operation, the customizable device interface 117 receives signals, data, control and status information, or any combination of these (collectively, component output data) from the user interface 106 and translates the component output data into application input data recognized by the telephone application program 119, thereby allowing a user to use the finger sensor 102 to scroll through the list of names shown on the display screen 101 and to select a name from the list of names by, for example, swiping or tapping his finger on the finger sensor 102. The customizable device interface 117 then receives component output data from the left arrow button 103 or the right arrow button 104 that is translated into application input data that perform the function of automatically dialing a telephone number corresponding to the selected name. For example, the user presses the left arrow button 103 to have the mobile telephone 100 automatically dial the home phone number corresponding to the selected name. Alternatively, the user presses the right arrow button 104 to have the mobile telephone 100 automatically dial the office number corresponding to the selected name.

Table 1 in FIG. 3 shows the relationship between the components of the user interface 106 in FIG. 1 and the function that each is configured to perform. Referring to FIGS. 1 and 3, Table 1 contains rows 251, 252, and 253. Row 251 shows that the finger sensor 102 is used to generate component output data that the telephone application program interprets as application input data corresponding to movement by a scroll wheel. The finger sensor 102 is thus said to emulate (e.g., is mapped to) a scroll wheel. Thus, when a user swipes his finger over the finger sensor 102, the list of user names is scrolled up or down, depending on the direction of the swipe. Device emulation using a finger sensor is described in more detail in U.S. patent application Ser. No. 10/873,393, titled “System and Method for a Miniature User Input Device,” and filed Jun. 21, 2004, which is hereby incorporated by reference. When the user swipes his finger across the finger sensor 102, the component output data generated by the finger sensor 102 are transmitted to the customizable device interface 116, which then translates the component output data into application input data that the application program recognizes as data generated by a scroll wheel, thereby scrolling the list of names shown in the display screen 101. In one embodiment, the name at the top of the list of names is automatically highlighted. Those skilled in the art will recognize that other names in the list can be highlighted in other ways in accordance with the present invention.

Still referring to FIGS. 1 and 3, row 252 shows that the left-arrow button 103 is mapped to the function of selecting the left-most telephone number (home telephone number) corresponding to the highlighted name. In a similar manner, the right-arrow button 104 is mapped to the function of selecting the right-most telephone number (office telephone number) corresponding to the highlighted name.

The structure used to map components of the user interface to corresponding functions can be configured in many ways. Preferably, the mappings (e.g., translations) are performed by one or more software programs stored in a memory of the customizable device interface 117. Alternatively, the mappings are formed as part of an application specific integrated circuit (ASIC) configured during assembly of the mobile telephone 100. Those skilled in the art will appreciate that the mapping can be performed in any number of ways.

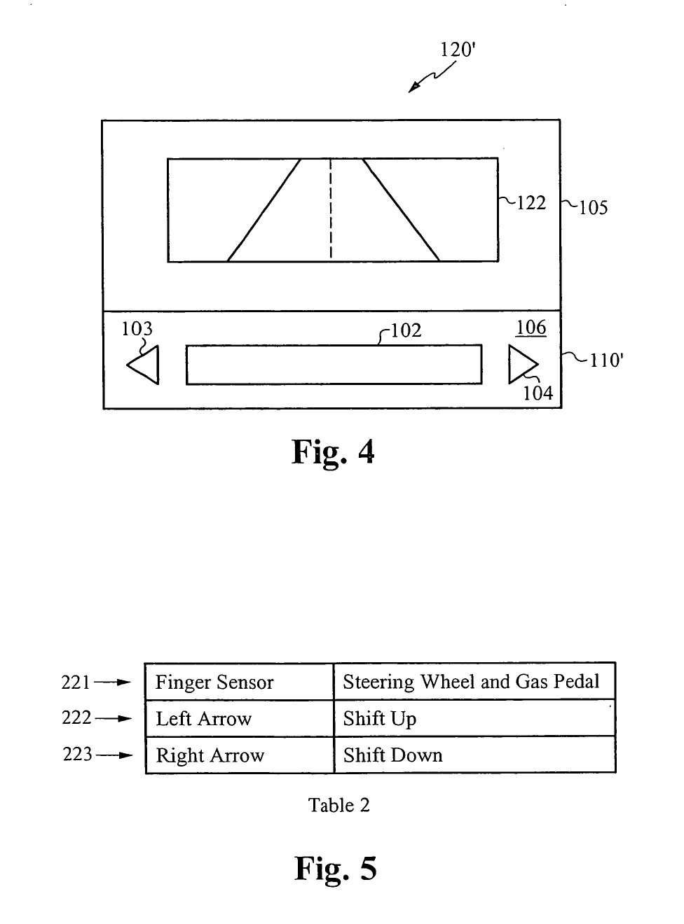

In accordance with the present invention, an original equipment manufacturer (OEM) is able to use the same user interface 106, package it in a different housing, and use it in another product, such as an electronic game. The OEM merely customizes a device interface in accordance with the present invention to package a selected housing containing a user interface with any number of electronic devices. FIG. 4 illustrates one example of how the user interface 106 is used in a different product, requiring that the input components be mapped to different functions.

FIG. 4 shows a portion of a mobile phone 120′ having a device interface that has been customized differently from the device interface described in FIG. 1. A user interface module 110′ comprises the user interface 106 and a customizable device interface (not shown). (Throughout the Specification, like-numbered elements refer to the same element.) The customizable device interface of FIG. 4 has been customized to map the components of the user interface 106 to the functions used to simulate a racing car game. The device interface of FIG. 4 has been customized so that the component output data generated by the finger sensor 102 is now used to emulate a steering wheel and gas pedal of a racing car for a racing car game executing on the mobile phone 120′. In this game, a user traces his finger along a surface of the finger sensor 102 to simulate the turning of a steering wheel for the racing car traveling along a driving course displayed on a display screen 122, which is mounted on the lid 105. The user is also able to change the pressure of his finger on the finger sensor 102 to emulate the pressure on an accelerator of the racing car. The user is able to press the left-arrow button 103 to emulate up-shifting and the right-arrow button 104 to emulate down-shifting of the gears of the racing car.

FIG. 5 shows Table 2, which illustrates the mapping performed by the customized device interface on the mobile telephone 120. Table 2 contains rows 221, 222, and 223, with each component shown in the left column of each row being mapped to a function in the corresponding right column. Thus, row 221 illustrates that the finger sensor 102 of the mobile telephone 120 is mapped to the function of emulating a steering wheel and gas pedal; row 222 illustrates that the left-arrow button 103 is mapped to the function of shifting the gears of the racing car up; and row 223 illustrates that the right-arrow button 104 is mapped to the function of shifting the gears of the racing car down.

While FIGS. 1 and 4 show a single user interface 106 used on the same electronic device (a mobile telephone), it will be appreciated that a single user interface is able to be mounted on any number of electronic devices and customized in accordance with the present invention to perform functions for operating the electronic device or an application executing on it. Moreover, as described below, user interfaces having any combination of user interface components are able to be customized in accordance with the present invention.

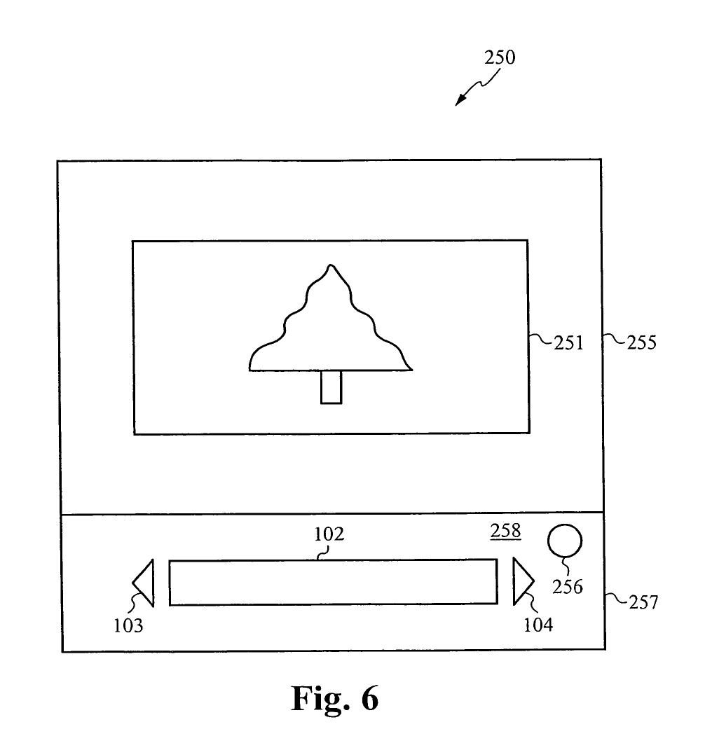

FIG. 6 shows a digital camera 250 comprising a top portion 255 and an interface module 257. The top portion 255 contains a display screen 251 and the user interface module 257 contains a user interface 258. The user interface 258 contains as user interface components the finger sensor 102, the left-arrow button 103, the right-arrow button 104, and a push button 256. Again, identical elements are used in FIGS. 1, 4, and 6 to highlight that similar or identical interface components are able to be customized to perform different functions depending, for example, on the device that the interface module is ultimately used.

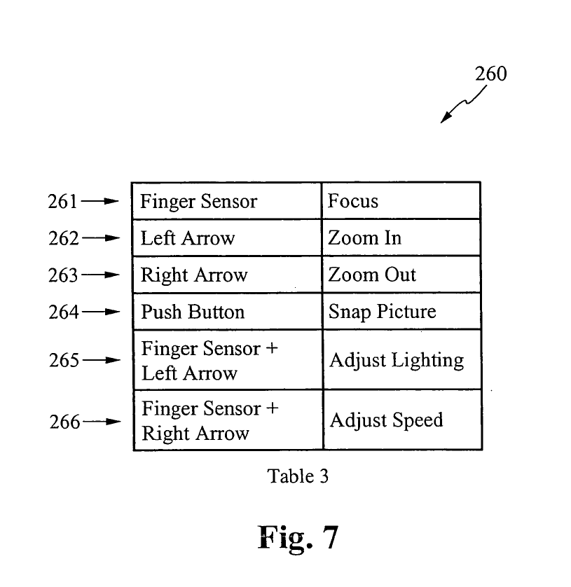

FIG. 7, containing Table 3, contains rows 261-266 showing how interface components in FIG. 6 map to camera-related functions. Multiple elements can be activated simultaneously (e.g., pressing the left-arrow button 103 and the push button 256 simultaneously) to perform specific functions. Thus, row 261 indicates that pressing the finger sensor 102 will control the focus of the digital camera 250 by, for example, translating (mapping) component output data into application input data used by a camera application program executing on the digital camera 250. Row 262 indicates that pressing the left-arrow button 103 zooms the focus on the digital camera 250 in. Row 263 indicates that pressing the right-arrow button 104 zooms the focus on the digital camera 250 out. Row 264 indicates that pressing the push button 256 snaps a picture on the digital camera 250. Row 265 indicates that pressing a finger on the finger sensor 102 while pressing the left-arrow button 103 adjusts the lighting for the digital camera 250. By pressing the finger sensor 102 and the left-arrow button 103 simultaneously to perform a function, the two are said to function cooperatively. And row 266 indicates that pressing a finger on the finger sensor 102 while pressing the right-arrow button 104 adjusts the speed for the digital camera 250.

It will be appreciated that a single electronic device is able to be used to perform any number of functions. For example, in one embodiment the mobile telephone 100 of FIG. 1 is configured to operate as a mobile telephone, as a digital camera, or both. In this case, the mobile phone is able to be used with a customized device interface so that it supports the functions of a mobile telephone, a digital camera, another electronic device, or any combination of these.

The present invention is also able to map activating (e.g., pressing or swiping) a finger sensor, a mechanical button, or both, to a function depending on the context. For example, when an electronic device is first powered on, a finger sensor is able to be mapped to the function of authenticating the user to determine whether he is to be allowed access to the electronic device. Later, when the electronic device is executing a game program, the finger sensor can be mapped to emulate a steering wheel.

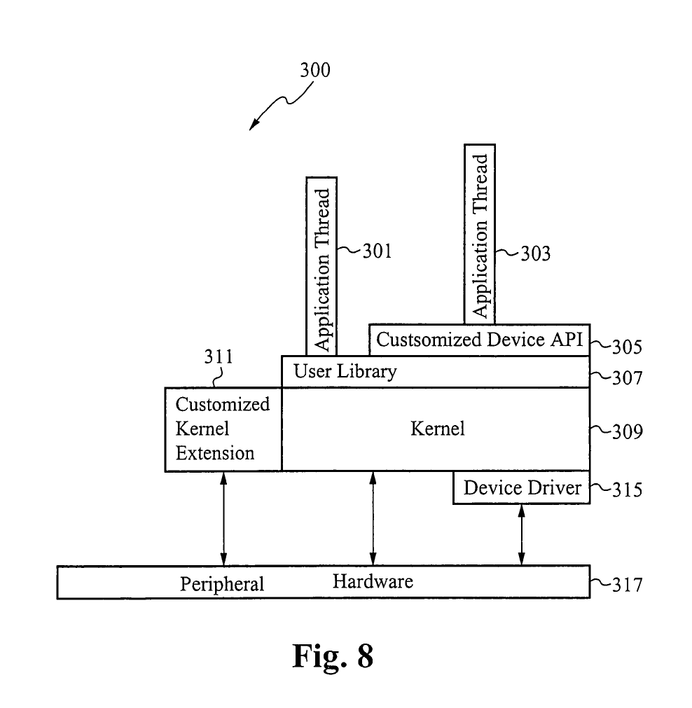

While FIG. 2 shows a general overview of the architecture for one embodiment of the present invention, FIG. 8 gives a more detailed view of a customized architecture 300 for practicing the invention using the Symbian OS™ for mobile telephones. The customized architecture 300 allows an application program (such as a telephone application program) to communicate with peripheral hardware devices 317, such as a finger sensor or mechanical components of a user interface such as the user interface 106 of FIG. 1. The customized architecture 300 comprises peripheral hardware 317 comprising any one or more of a finger sensor, a left-arrow button, a right-arrow button, a push button, a joy stick, a jog dial, a scroll wheel, a pressure sensitive button, a touch screen, etc. The peripheral hardware 317 is coupled to a kernel extension 311, a kernel 309, and a device driver 315. The kernel 309 provides the basic operating system functions, including providing access to necessary peripherals such as timers. The kernel extension 311 extends the functioning of the kernel 309 by allowing the operating system to access the peripheral hardware 317. The kernel 309 in turn is coupled to the device driver 315 and to a user library 307 that allows application programs (including threads 301 and 303) to access the functions of the kernel 307. The user library is coupled to the application thread 301 and to a customized device API 305 that is also coupled to the application thread 303.

In a preferred embodiment, the customized device API 305 corresponds to a customized device interface in accordance with the present invention. In this embodiment, the customized device API 305 translates a function normally associated with a user interface component into a function required by an application program. Thus, for example, if a finger sensor is used to emulate a steering wheel, the system function associated with the finger sensor is mapped to a function associated with the steering wheel. For example, if the architecture 300 passes messages to signify the occurrence of a steering wheel movement, the finger sensor's component output data is mapped to a message that the application thread 303 recognizes as generated by a steering wheel. Alternatively, the architecture can use event generation or other methods to recognize the occurrence of a steering wheel movement.

In one example of operation, a finger sensor is used to emulate a steering wheel to be used on game device. In this example, a user swipes his finger on a finger sensor that forms part of the peripheral hardware 317, which the device driver 315 uses to generate component output data. The kernel 309 in conjunction with the user library 307 translates this component output data to application input data (e.g., a system function) recognizable as that generated by a finger sensor. The customized device API 305 translates this application input data into that recognizable as generated by a steering wheel. This application input data is then transmitted to the application thread 303, such as a car racing application program, which uses the input data to emulate turning the steering wheel.

The customized device API 305 is able to be loaded when a device containing the customized architecture 300 is configured, such as at an OEM. In accordance with the invention, a single component, such as the user interface 106, is able to be installed on many different products, and the mapping of its input components determined when the functioning of (e.g., the application programs executing on) the electronic device is determined. Thus, for example, if the input module 106 (FIG. 1) is placed in a mobile telephone, a customized device API can be loaded when the mobile phone is assembled so that the functioning of the input module 106 corresponds to that shown in Table 1 of FIG. 3. Alternatively, if the input module 106 is placed in a game device, a customized device API can be loaded when the game device is assembled so that the functioning of the input module 106 corresponds to that shown in Table 2 of FIG. 5. Thus, the customized device API 305 is able to be configured according to the present invention to allow a single input module to be used in a variety of products using a variety of packages.

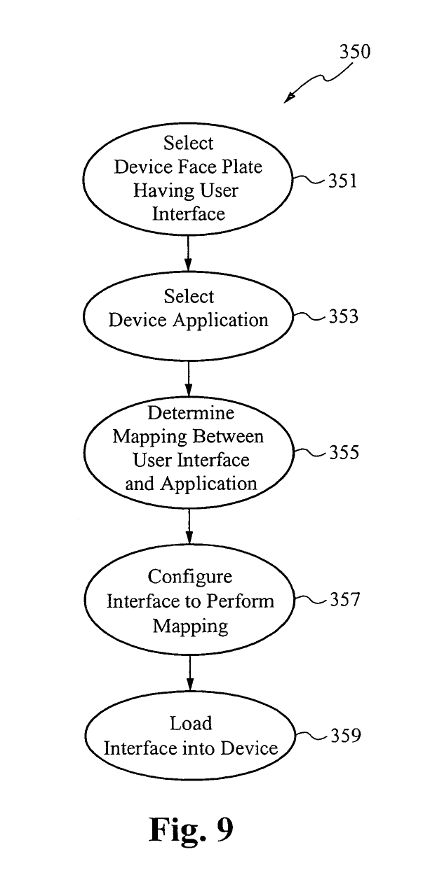

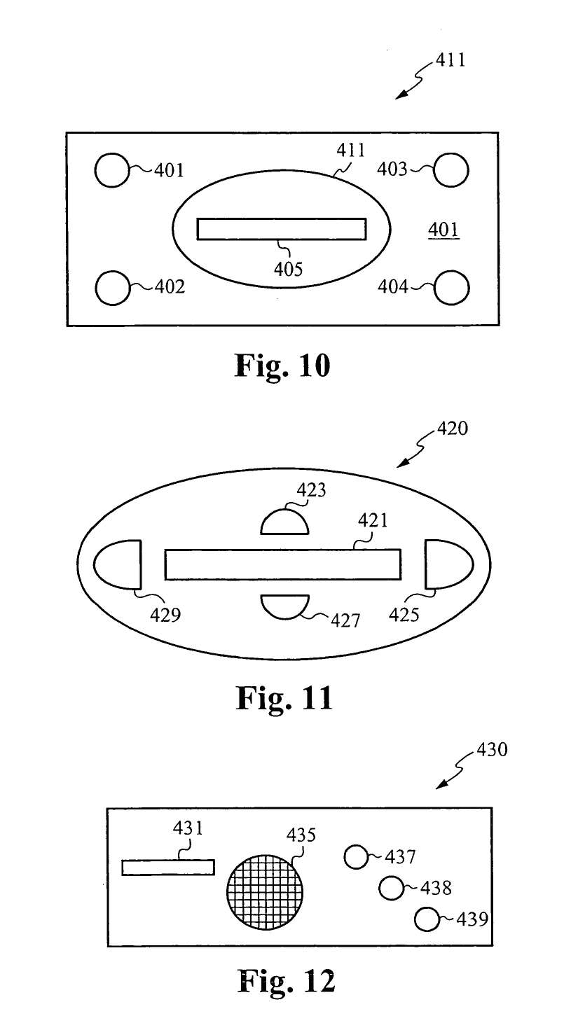

FIG. 9 is a flow chart 350 showing the steps used to customize a device interface in accordance with one embodiment of the present invention. First, in the step 351, a face plate having a user interface is selected based, for example, on its look and feel. Next, in the step 353, the functions that the underlying electronic device is used to perform is selected. In this step, for example, the application of the underlying device can be the emulation of a racing car, telephone and address book functions such as scrolling through a phone list and dialing telephone numbers, etc. Next, in the step 355, the mapping of the user interface components to the function of each component is determined, such as shown in Tables 1-3. Next, in the step 357 a customized device API (e.g., element 305 in FIG. 10) is configured to reflect the mapping determined in the step 355. Next, in the step 359, the customized API is loaded onto the electronic device, such as a mobile telephone, a game device, a digital camera, etc.

It will be appreciated that not all interface components on a user interface must be mapped to a corresponding function. Some user interface components may have no function when assembled on an electronic device.

It will also be appreciated that components in the architecture 300 are able to be implemented in other ways. For example, in one embodiment, the device driver 315 is used to map component output data into data that is ultimately recognized by the application thread 303 as application input data for a function supported by the application thread 303. In one embodiment, the device driver is implemented as an ASIC.

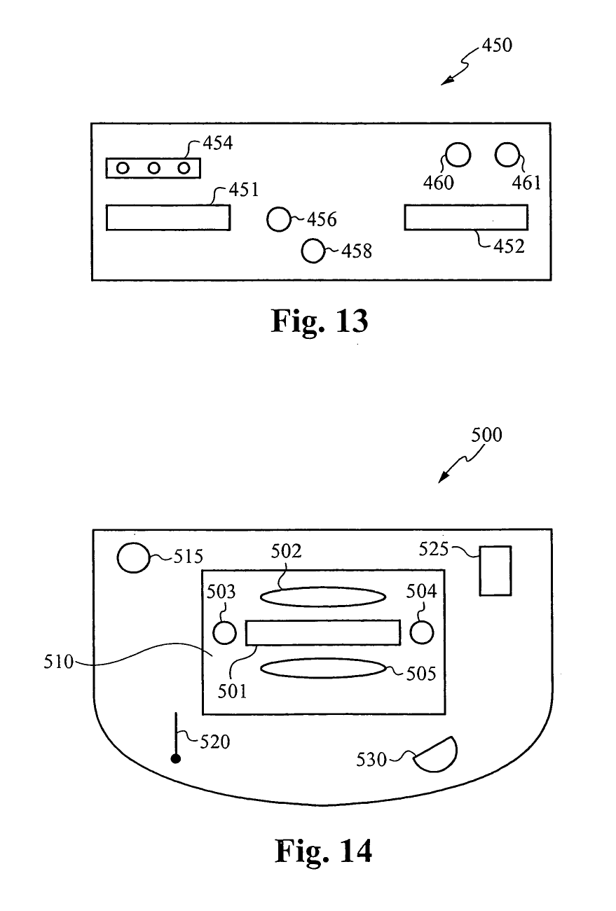

FIGS. 10-14 show several housings each having a corresponding user interface coupled to a device interface customized in accordance with the present invention. Each device interface is able to be customized for use on any number of electronic devices in accordance with the present invention. FIG. 10 shows a housing 411 having a face containing user interface components that include four push buttons 401-404 and a button 411 that also supports a finger sensor 405. Using this configuration, the user interface components are able to be configured to perform a variety of functions. For example, the finger sensor 405 is used to authenticate a user (such as by using an authentication module well known in the art), scroll through a phone list, or emulate a steering wheel. Referring to FIG. 10, a user is able to swipe or place a finger on the finger sensor 405, push the button 411, or do both simultaneously, all to perform a corresponding function. FIG. 11 shows a housing 420 having a face containing user interface components that include a finger sensor 421 and push buttons 423, 425, 427, and 429. FIG. 12 shows a housing 430 having a face containing user interface components that include a finger sensor 431, a speaker 435, and push buttons 437-439. FIG. 13 shows a housing 450 having a face containing user interface components that include a first finger sensor 451, a second finger sensor 452, an LED bank 454, and push buttons 456, 458, 460, and 461. FIG. 14 shows a housing 500 having a face containing user interface components that include a finger sensor 501, push buttons 502-505, a scroll wheel 525, a jog dial 515, a joy stick 520, and a push button 530. As FIGS. 10-14 show, housings used in accordance with the present invention can have any combination of size and shape selected for their look and feel or using other criteria.

In accordance with embodiments of the present invention, output displays such as the speaker 435 (FIG. 12) and LED bank 454 (FIG. 13) are coupled to user input components such as finger sensors and push buttons to indicate, for example, that a button has been pushed. In other embodiments, the speakers are coupled to audio outputs such as when the underlying electronic device is a game system. In these other embodiments, the speakers are able to emulate sounds generated by the game, such as bombs exploding, etc. Also in these other embodiments, the LED bank 454 can be used to simulate explosions and other features of the game. As in other embodiments of the present invention, the output displays are also mapped to user interface components, to outputs generated by an application executing on an electronic device, or any combination of these.

By customizing a device interface in accordance with the present invention, electronic devices are able to be coupled with face plates having many combinations of interface components. A system and method in accordance with the present invention thus allow OEMs to use off-the-shelf application programs and device drivers, merely requiring that they customize the device interface. Such minimum modifications save time and money and allow electronic devices to use any number of ready-made application programs and device drivers on the market.

Systems and methods in accordance with the present invention also offer more combinations of interface components to be mapped to functions executable on the electronic device. The number of functions supported by, and thus the capabilities of, the electronic device is extended.

It will be appreciated that many variations can be made to the embodiments of the present invention. For example, while the above embodiments describe stand-alone systems, other electronic devices, such as a game controller, such as, but not limited to, the XBOX™, Nintendo Game Cube™, Sony PS, and Sony PS2, are able to be configured in accordance with the present invention. Other output components, such as back lights and LCD panels, are able to form part of the user interface. And while swipe finger sensors, such as capacitive, thermal, and optical sensors, are described in the embodiments above, placement sensors can also be used. It will be readily apparent to one skilled in the art that various modifications may be made to the embodiments without departing from the spirit and scope of the invention as defined by the appended claims.

I claim:

1. A system for providing an input to an electronic device, the system comprising:
a. a user interface for receiving a user input, the user interface comprising a finger sensor and a mechanical input component; and
b. a device interface coupled to the user interface, the device interface configured to selectively map an output of the user interface to an input for the electronic device.

2. The system of claim 1, wherein the mechanical input component comprises at least one of a push button, a scroll wheel, a joy stick, a touch pad, a switch, a dial, and a pressure sensor.

3. The system of claim 1, wherein the input for the electronic device corresponds to a cooperative mapping of the output of the finger sensor and the output of the mechanical input component.

4. The system of claim 1, wherein the input for the electronic device corresponds to a function supported by an application program executing on the electronic device.

5. The system of claim 4, wherein the function comprises any one of scrolling through a list of telephone numbers, selecting a telephone number, and automatically dialing a selected telephone number.

6. The system of claim 4, wherein the function comprises any one of generating a computer game display and controlling the game display.

7. The system of claim 4, wherein the function comprises any one of focusing a digital camera and capturing a picture on the digital camera.

8. The system of claim 1, wherein the user interface and the device interface are configured to form an integrated module with the electronic device.

9. The system of claim 1, wherein the device interface comprises a memory containing a sequence of executable program instructions for mapping the output of the user interface to the input for the electronic device.

10. The system of claim 1, wherein the device interface comprises an application specific integrated circuit configured to map the output of the user interface to the input for the electronic device.

11. The system of claim 1, further comprising an authentication unit coupled to the finger sensor and configured to authenticate a user using finger image data read by the finger sensor.

12. The system of claim 4, wherein the input for the electronic device depends on a context of the application program.

13. The system of claim 1, wherein the finger sensor is a swipe sensor.

14. The system of claim 13, wherein the swipe sensor is any one of an optical sensor, a thermal sensor, or a capacitive sensor.

15. The system of claim 1, wherein the finger sensor is a placement sensor.

16. The system of claim 1, wherein the user interface further comprises any one or more of an LED, an LCD panel, a back light, and a speaker.

17. The system of claim 1, further comprising an electronic device coupled to the device interface, the electronic device selected from the group consisting of a mobile telephone, a portable computer, a digital camera, a portable game system, a game controller, a personal digital assistant, a digital audio player, and a digital video player.

18. A system comprising:
a. an electronic device;
b. a finger sensor for receiving a first input to control the electronic device; and
c. a mechanical input portion for receiving a second input to control the electronic device,
wherein the finger sensor and the mechanical input portion are configured to operate cooperatively with each other to control the electronic device.

19. The system of claim 18, wherein the mechanical input portion comprises at least one of a push button, a scroll wheel, a joy stick, a touch pad, a switch, a dial, and a pressure sensor.

20. The system of claim 18, wherein the electronic device is a device selected from the group consisting of a mobile telephone, a portable computer, a digital camera, a portable game system, a personal digital assistant, a digital audio player, and a digital video player.

21. The system of claim 18, further comprising a device interface for mapping outputs from the finger sensor and the mechanical input portion to functions for controlling the electronic device.

22. The system of claim 21, wherein the user interface, the electronic device, and the device interface are packaged into an integrated module.

23. The system of claim 21, wherein the device interface comprises a memory containing a sequence of executable program instructions for mapping the outputs from the finger sensor and the mechanical input portion to corresponding functions for controlling the electronic device.

24. The system of claim 21, wherein the device interface comprises an application specific integrated circuit that forms part of the device interface.

25. The system of claim 21, wherein one of the functions comprises authenticating a user using the finger sensor.

26. The system of claim 18, wherein the finger sensor is a swipe sensor.

27. The system of claim 26, wherein the swipe sensor is any one of an optical sensor, a thermal sensor, and a capacitive sensor.

28. The system of claim 18, wherein the finger sensor is a placement sensor.

29. The system of claim 18, further comprising an output device selected from the group consisting of an LED, an LCD panel, a back light, and a speaker.

30. The system of claim 18, further comprising an authentication module coupled to the finger sensor.

31. A method of configuring an electronic system comprising:
a. selecting a user interface comprising a finger sensor and a mechanical component;
b. selecting an electronic device; and
c. configuring a device interface between the user interface and the electronic device, wherein the device interface is configured to cooperatively map an output from the finger sensor and an output from the mechanical component to an output for controlling an application executing on the electronic device.

32. The method of claim 31, wherein the mechanical component comprises a device selected from the group consisting of a push button, a scroll wheel, a joy stick, a touch pad, a switch, a dial, and a pressure sensor.

33. The method of claim 31, wherein the electronic device is a device selected from the group consisting of a mobile telephone, a portable computer, a digital camera, a portable game system, a personal digital assistant, a digital audio player, and a digital video player.

34. The method of claim 31, wherein the electronic device is a mobile telephone and the application is used to perform a function on the electronic device, the function comprising at least one of scrolling through a list of telephone numbers, selecting a telephone number, and automatically dialing a selected telephone number.

35. The method of claim 31, wherein the electronic device is a portable game system and the application is used to perform a function on the portable game system, the function comprising at least one of generating a computer game display and controlling the game display.

36. The method of claim 31, wherein the electronic device is a digital camera and the application is used to perform a function on the digital camera, the function comprising at least one of focusing the digital camera and capturing a picture on the digital camera.

37. The method of claim 31, further comprising packaging the user interface, the electronic device, and the device interface into an integrated module.

38. The method of claim 31, wherein the device interface comprises a memory containing a sequence of executable program instructions for cooperatively mapping the output from the finger sensor and the output from the mechanical component to the output for controlling the application.

39. The method of claim 38, wherein configuring the device interface comprises storing the sequence of executable program instructions into the memory.

40. The method of claim 31, wherein configuring the device interface comprises configuring an application specific integrated circuit that forms part of the device interface.

41. The method of claim 31, wherein the application comprises authenticating a user using the finger sensor.

42. The method of claim 31, wherein the finger sensor is a swipe sensor.

43. The method of claim 42, wherein the swipe sensor is one of an optical sensor, a thermal sensor, and a capacitive sensor.

44. The method of claim 31, wherein the finger sensor is a placement sensor.

45. The method of claim 31, wherein the user interface comprises an output device selected from the group consisting of an LED, an LCD panel, a back light, and an audio speaker.

46. The method of claim 31, wherein the output for controlling an application depends in the context of the application.
